(19) United States
(12) Patent Application Publication
(10) Pub. No.: US 2017/0148248 A1
(43) Pub. Date: May 25, 2017

(54) PICKUP MECHANISM, PAPER CURRENCY PROCESSING MACHINE AND SHEET MEDIUM PROCESSING DEVICE

(71) Applicant: Shandong New Beiyang Information Technology Co., Ltd., Shandong (CN)

(72) Inventors: Fengbo XU, Shandong (CN); Guowei QI, Shandong (CN); Shuxun DONG, Shandong (CN)

(73) Assignee: Shandong New Beiyang Information Technology Co., Ltd., Shandong (CN)

(21) Appl. No.: 15/325,574

(22) PCT Filed: Jun. 9, 2015
(86) PCT No.: PCT/CN15/83683

§ 371 Date: Jan. 11, 2017

(30) Foreign Application Priority Data
Jul. 11, 2014 (CN) 201420384354.6

(51) Int. Cl. G07D 11/00; B65H 7/14; B65H 7/18; B65H 3/06

(52) U.S. Cl. CPC G07D 11/0024; B65H 3/0646; B65H 7/14; B65H 7/18; B65H 2701/1912

(57) ABSTRACT

A pickup mechanism, paper currency processing machine and sheet medium processing device are provided. The pickup mechanism includes a pickup roller (1). The pickup roller (1) includes a shaft (11) and a sleeve (12), a part of a periphery of the sleeve (12) includes a high-friction part (122). The pickup mechanism further includes a detecting component (5). The detecting component (5) includes a detecting disc (52) coaxially and fixedly connected with the shaft (11), and a sensor (51) matched with the detecting disc (52), and a position detecting aperture (521) is arranged on the detecting disc (52). An end position of the position detecting aperture (521), matched with the sensor (51), is associated with a position where the high-friction part of the pickup roller is located along a rotation direction of the detecting disc (52), so as to control a rotation stop position of the pickup roller (1).

This application is a National Stage Entry of PCT International Application No. PCT/CN2015/083683, filed Jul. 9, 2015 claims priority to Chinese Application No. 201420384354.6, entitled “PICKUP MECHANISM, PAPER CURRENCY PROCESSING MACHINE AND SHEET MEDIUM PROCESSING DEVICE”, which was filed with the state intellectual property office of the People's Republic of China on Jul. 11, 2014, the entirety of which are incorporated herein by reference.

### TECHNICAL FIELD

The present disclosure relates to a pickup mechanism, as well as a paper currency processing machine and a sheet medium processing device using the same.

### BACKGROUND

As shown in FIG. 1, in order to process a plurality of paper currencies in batches, a pickup mechanism, a separating mechanism 2′ and a driving mechanism are generally arranged at a paper currency inlet in an existing paper currency processing machine such as a paper currency sorter and a cash register, so that a stack of paper currencies placed at the paper currency inlet are successively fed into the paper currency processing machine one by one to be subjected to processing operations, such as authentication, sorting and so on.

The pickup mechanism includes a pickup roller 1′ having a shaft 11′ and a sleeve 12′ fixedly arranged at a periphery of the shaft 11′. When the shaft 11′ rotates, the sleeve 12′ rotates synchronously along with the shaft. The sleeve 12′ includes a high-friction part 121′ configured along a circumference of the sleeve 12′ and a base part 122′. Friction force between the high-friction part 121′ and paper currencies is larger than that between the paper currencies, and friction force between the base part 122′ and the paper currencies is smaller than that between the paper currencies. The separating mechanism 2′ is positioned downstream of the pickup mechanism in a paper currency conveying direction, and includes a separating roller 21′ and a reversal roller 22′ which are arranged oppositely at an interval, and a distance between the separating roller 21′ and the reversal roller 22′ is larger than thickness of a single paper currency and is smaller than thickness of two paper currencies. The driving mechanism includes a first motor M1 configured to drive the pickup roller 1′ and the separating roller 21′ to rotate in a paper currency feeding direction, and a second motor M2 configured to drive the reversal roller 22′ to rotate in a paper currency returning direction.

When a plurality of paper currencies are stacked on a tray 8′, the first motor M1 drives the pickup roller 1′ and the separating roller 21′ to rotate in the paper currency feeding direction, and the second motor M2 drives the reversal roller 22′ to rotate in the paper currency returning direction. When the high-friction part 121′ of the pickup roller 1′ is contacted with the paper currencies, the high-friction part 121′ drives a paper currency contacted therewith to enter a position between the separating roller 21′ and the reversal roller 22′. If a plurality of paper currencies are fed between the separating roller 21′ and the reversal roller 22′ by the pickup roller 1′, the separating roller 21′ drives the paper currency contacted therewith to convey downstream, and the reversal roller 22′ drives the paper currency contacted therewith to convey upstream. That is to say, only the paper currency contacted with the separating roller 21′ is conveyed downstream, so that the paper currencies are successively fed into the paper currency processing machine one by one.

After the paper currency processing being completed by the above pickup mechanism every time, a stop position of the high-friction part 121′ of the pickup roller 1′ is uncertain, which is easy to result in idle rotation and cause sliding when the paper currency conveying is started next time. No effective solution for improving the reliability of the pickup mechanism has been proposed in the existing art.

### SUMMARY

The objective of the present disclosure is to provide a pickup mechanism with high reliability. Another objective of the present disclosure is to provide a paper currency processing machine and a sheet medium processing device using the pickup mechanism.

According to an aspect of the present disclosure, a pickup mechanism is provided. The pickup mechanism includes a pickup roller. The pickup roller includes a shaft and a sleeve, a periphery of the sleeve includes a high-friction part. The pickup mechanism further includes a detecting component. The detecting component includes a detecting disc coaxially and fixedly connected with the shaft and a sensor matched with the detecting disc. A position detecting aperture is arranged on the detecting disc, along a rotation direction of the detecting disc, an end position of the position detecting aperture, matched with the sensor, and is associated with a position where the high-friction part of the pickup roller is located, so as to control a rotation stop position of the pickup roller.

Further, the above pickup mechanism further includes a plurality of speed measuring apertures which are arranged on a same circumference together with the position detecting aperture. A detection span under a situation that the position detecting aperture is matched with the sensor is unequal to a detection span under a situation that the speed measuring aperture is matched with the sensor.

Further, along the rotation direction of the detecting disc, the end position of the position detecting aperture, matched with the sensor, is aligned to or staggered with a starting position of the high-friction part.

Further, the above position detecting aperture and the speed measuring apertures are all round holes, and a diameter of the position detecting aperture is larger than that of each speed measuring aperture.

Further, the position detecting aperture and the speed measuring apertures are all sector-shaped ring sections, and the central angle of the position detecting aperture is larger than that of each speed measuring aperture.

Further, along a circumferential direction of the detecting disc, a detection span under a situation that entity parts at two sides of the position detecting aperture are matched with the sensor is larger than a detection span under a situation that an entity part between two adjacent speed measuring apertures is matched with the sensor.

Further, the above sensor is a photoelectric sensor and includes a light emitter and a light receiver which are arranged oppositely. The detecting disc is positioned between the light emitter and the light receiver.

According to another aspect of the present disclosure, a paper currency processing machine is provided, including a paper currency tray, a pickup mechanism and a paper currency separating mechanism positioned downstream of the pickup mechanism, the pickup mechanism is the pickup mechanism as described above.

Further, the above paper currency processing machine is a paper currency sorter, and includes a paper currency inlet and at least two paper currency outlets, the paper currency tray and the pickup mechanism are arranged at the paper currency inlet.

The present disclosure further provides a sheet medium processing device, including the pickup mechanism as described above.

The pickup mechanism provided by the present disclosure includes a pickup roller and a detecting component, and the detecting component includes a detecting disc synchronously rotating with the pickup roller, and a sensor matched with the detecting disc, a position detecting aperture is arranged on the detecting disc, and an end position of the position detecting aperture, matched with the sensor, is associated with the circumferential position of the high-friction part of the pickup roller, so as to control the rotation stop position of the pickup roller. Therefore, a problem of uncertain stopping position of the pickup roller is solved and the reliability of the pickup mechanism is improved.

Besides the objectives, features and advantages described above, the present disclosure further has other objectives, features and advantages, which will be further described in details in combination with the drawings.

### BRIEF DESCRIPTION OF DRAWINGS

Drawings, which constitute a part of the description and are used for further understanding the present disclosure, illustrate embodiments of the present invention and are used for explaining the principle of the present disclosure together with the description. In the drawings:

FIG. 1 is a structural schematic view of a paper currency feeding mechanism in the existing art;

FIG. 2a is a structural schematic of a pickup mechanism according to embodiment I of the present invention;

FIG. 2b is a structural front view of a pickup mechanism according to embodiment I of the present invention;

FIG. 3 is a structural side view of a pickup mechanism according to embodiment I of the present invention, with a pickup roller being stopped at a set stop position;

FIG. 4 is a schematic of output signals of a detecting component of a pickup mechanism according to embodiment I of the present invention;

FIG. 5 is a structural side view of a pickup mechanism according to embodiment II of the present invention, with the pickup roller being stopped at a set stop position;

FIG. 6 is a schematic of output signals of a detecting component of a pickup mechanism according to embodiment II of the present invention;

FIG. 7 is a structural side view of a pickup mechanism according to embodiment III of the present invention, with the pickup roller being stopped at a set stop position; and

FIG. 8 is a structural sectional view of an embodiment of a paper currency processing machine using the pickup mechanism provided by the present disclosure.

List of reference numerals

| | |
|---|---|
| 1. Pickup roller; | 5. Detecting component; |
| 11. Shaft; | 12. Sleeve; |
| 111. Pulley; | 12a. Sectional sleeve; |
| 121. Base body; | 122. High-friction part; |
| 51. Sensor; | 52. Detecting disc; |
| 511. Light emitter; | 512. Light receiver; |
| 521. Position detecting aperture; | 522. Speed measuring aperture; |
| 523. First entity part; | 523’. Second entity part; |
| S0. Paper currency inlet; | S3. Paper currency returning port; |
| P. Main passage; | 100. Pickup mechanism; |
| 200. Separating mechanism; | 300. Paper currency authentication |
| mechanism; | |
| 8. Tray; | a. Starting position; |
| b. End position; | 210. Separating roller; |
| 220. Reversal roller; | 310. Image detecting mechanism; |
| 320. Magnetic detecting mechanism; | 401. Conveying roller set; |
| 402. Impeller; | 510. First reverser; |
| 520. Second reverser; | P. Main passage; |
| Pl. First auxiliary passage; | P2. Second auxiliary passage. |

### DETAILED DESCRIPTION

Embodiments of the present invention are described below in details in combination with the drawings, but the present disclosure can be implemented by multiple different modes limited and covered by the claims.

After the paper currency process being completed every time by the pickup roller of the pickup mechanism in the existing art, the stop position of the high-friction part of the pickup roller is uncertain. As a result, when the paper currency conveying is started next time, it is easy to result in idle rotation and cause sliding in conveyance. Meanwhile, in the case that the paper currencies are processed in batch, if the pickup roller is always driven to rotate by a constant torque, rotation speed of the pickup roller is faster due to small frictional resistance when a processed paper currency is new, while rotation speed of the pickup roller is slower due to large frictional resistance when a processed paper currency is old. Thus, two pieces of successive paper currency are easy to be connected end to end and further cause a jam of the paper currencies. Therefore, no effective solution for improving the reliability of the pickup mechanism has been proposed in the existing art.

The inventor found that the reason for paper currency jam of the pickup mechanism in the existing art lies in: the pickup roller is driven to rotate by a constant torque. As a result, the rotation speed of the pickup roller is faster due to small frictional resistance when a processed paper currency is new, while the rotation speed of the pickup roller is slower due to large frictional resistance when a processed paper currency is old. Thus, two pieces of successive paper currency are easy to be connected end to end and further cause a jam of the paper currencies. In addition, after the paper currency process being completed by the above pickup mechanism every time, the stop position of the high-friction part of the pickup roller is uncertain. As a result, when the paper currency conveying is started next time, it is easy to result in idle rotation and cause sliding in conveyance. On the basis of the above, it can be understood that the above problems can be avoided by adjusting the rotation speed of the pickup roller and controlling the stop position of the high-friction part, and the reliability of the pickup mechanism can be further improved.

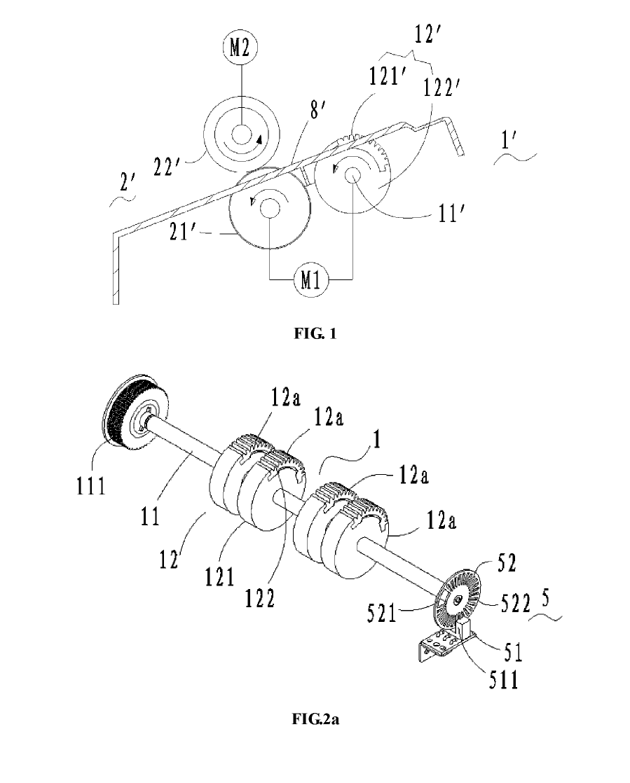

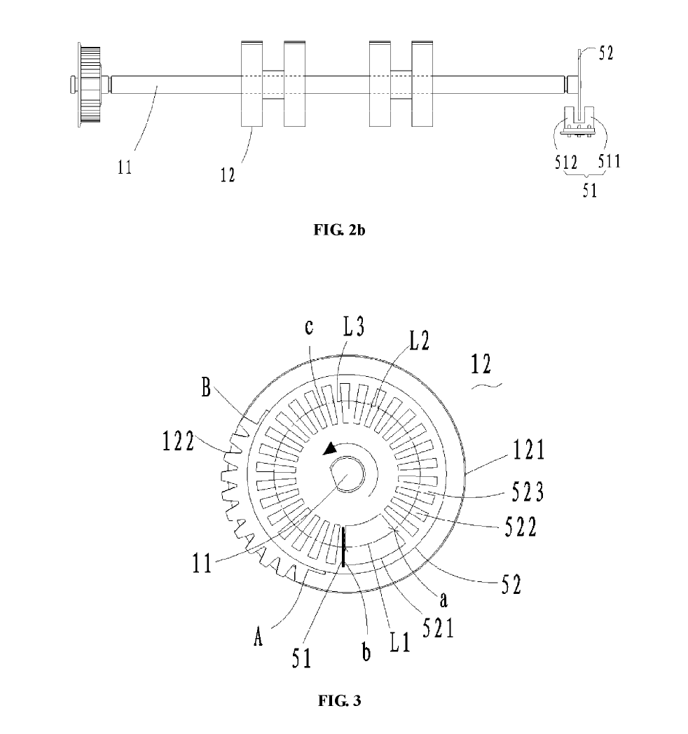

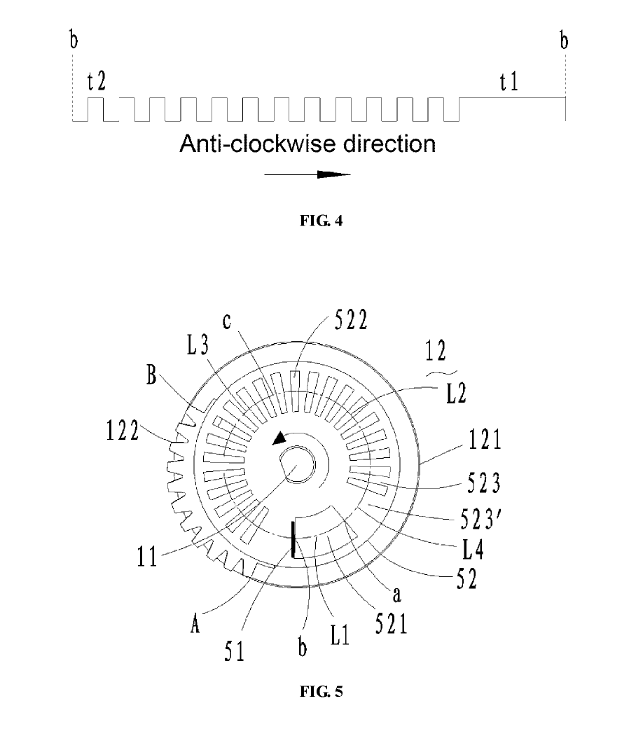

FIG. 2a is a structural schematic view of a pickup mechanism according to embodiment I of the present invention, and FIG. 2b is a structural front view of the pickup mechanism according to embodiment I of the present invention. As shown in FIG. 2a and FIG. 2b, the pickup mechanism includes a detecting component 5 and a pickup roller 1 having a shaft 11 and a sleeve 12. The shaft 11 extends in a width direction of the paper currencies, and two ends of the shaft 11 are supported by a frame (not shown in the figure). Moreover, a pulley 111 is provided at one end of the shaft 11 for transmission connection with a driving component of a paper currency processing machine using the pickup mechanism. Driven by the driving component, the shaft 11 can rotate about it's axis along a set direction (an anticlockwise direction as shown in FIG. 3). The sleeve 12 is fixedly arranged at a periphery of the shaft 11, which can be an integrated roller with a length matched with the maximum width of paper currencies, and can also be sectional rollers separately arranged along the axial direction of the shaft 11. When the shaft 11 rotates, the sleeve 12 synchronously rotates along with the shaft 11. In the present embodiment, the sleeve 12 includes four sectional sleeve 12a arranged along the axial direction of the shaft 11, and every two of the four sectional sleeve 12a are arranged in pairs in a manner of bilateral symmetry.

The sleeve 12 includes a base body 121 and a high-friction part 122 along the peripheral direction. A friction coefficient al between the base body 121 and the paper currency is less than a friction coefficient α0 between the paper currencies, i.e., α1<α0. A friction coefficient α2 between the high-friction part 122 and the paper currency is greater than the friction coefficient α0 between the paper currencies, i.e., α2>α0>α1. The high-friction part 122 is made from rubber materials. The length of the high-friction part 122 along the circumferential direction of the sleeve 12 is greater than or equal to a displacement distance of the paper currencies driven by the pickup roller 1. The high-friction part 122 has a starting position A and an end position B along a rotation direction of the pickup roller 1.

The detecting component 5 is configured to detect the rotation speed of the pickup roller 1, and detect whether the high-friction part 122 of the pickup roller 1 rotates to a set stop position. The detecting component 5 includes a sensor 51 and a detecting disc 52. The sensor 51 is fixedly arranged on the frame, which may be a photoelectric sensor and includes a light emitter 511 and a light receiver 512 oppositely arranged at an interval. The detecting disc 52 is fixedly connected with the shaft 11 of the pickup roller 1, and is inserted between the light emitter 511 and the light receiver 512. When the pickup roller 1 rotates, the detecting disc 52 rotates synchronously along with the pickup roller 1, and is always positioned in an optical path between the light emitter 511 and the light receiver 512 of the sensor 51.

FIG. 3 is a structural side view of the pickup mechanism according to embodiment I of the present disclosure. For clarity, the optical path of the sensor 51 is shown by a black block in FIG. 3, and the structures of other parts of the sensor 51 are omitted. As shown in FIG. 3, the detecting disc 52 includes a position detecting aperture 521 and a plurality of speed measuring apertures 522 which are uniformly distributed along the circumference of a circle c, and an entity part. A center of the circle c is the axis of the shaft 11. In the present embodiment, the entity part includes a plurality of first entity parts 523. The speed measuring aperture 522 and the first entity part 523 are alternatively arranged on the circle c in sequence, and the position detecting aperture 521 is positioned between two first entity parts 523.

When the detecting disc 52 rotates, the position detecting aperture 521, the speed measuring apertures 522 and the first entity parts 523 can pass through the optical path between the light emitter 511 and the light receiver 512 of the sensor 51. Along the rotation direction of the pickup roller 1, a detection span L1, under a situation that the position detecting aperture 521 is matched with the sensor 51, is unequal to a detection span L2, under a situation that the speed measuring aperture 522 is matched with the sensor 51. That is to say, a time needed by the sensor 51 for passing through the position detecting aperture 521 is unequal to a time needed for passing through the speed measuring aperture 522 when the pickup roller 1 rotates at a constant speed. The end position b of the position detecting aperture 521 when being matched with the sensor 51 and the starting position A of the high-friction part 122 of the sleeve 12 of the pickup roller 1 are separated for a set angle, along the rotation direction of the pickup roller 1. A first entity part 523 adjacent to the end position b of the position detecting aperture 521 is positioned in the optical path between the light emitter 511 and the light receiver 512 when the high-friction part 122 of the pickup roller 1 stops at the set stop position.

In the present embodiment, along the rotation direction of the pickup roller 1, the detection span L1 under the situation that the position detecting aperture 521 is matched with the sensor 51 is larger than the detection span L2 under the situation that the speed measuring aperture 522 is matched with the sensor 51. That is to say, the time needed by the sensor 51 for passing through the position detecting aperture 521 is longer than the time needed for passing through the speed measuring aperture 522 when the pickup roller 1 rotates at a constant speed. The position detecting aperture 521 and the speed measuring apertures 522 are all sector-shaped ring sections, and a detection span L3 under a situation that the first entity part 523 is matched with the sensor 51 is equal to the detection span L2 under the situation that the speed measuring aperture 522 is matched with the sensor 51.

The detecting disc 52 rotates synchronously along with the pickup roller 1. When a first entity part 523 of the detecting disc 52 is positioned in the optical path between the light emitter 511 and the light receiver 512 of the sensor 51, the first entity part 523 blocks the optical path between the light emitter 511 and the light receiver 512, thus the light receiver 512 of the sensor cannot receive light transmitted from the light emitter 511 and the sensor 51 outputs a first detection signal, such as low level. When the position detecting aperture 521 or the speed measuring aperture 522 of the detecting disc 52 are positioned in the optical path between the light emitter 511 and the light receiver 512 of the sensor 51, the light receiver 512 of the sensor 51 can receive light transmitted from the light emitter 511, and the sensor 51 outputs a second detection signal, such as high level. The time needed by the sensor 51 for passing through the position detecting aperture 521 is longer than the time needed for passing through the speed measuring aperture 522 when the pickup roller 1 rotates at a constant speed. Therefore, when the pickup roller 1 rotates at a constant speed, time t1 for outputting the second detection signal by the sensor 51 when the position detecting aperture 521 is matched with the sensor 51 is much greater than time t2 for outputting the second detection signal by the sensor 51 when the speed measuring aperture 522 is matched with the sensor 51.

FIG. 4 is a schematic of an output signal of the detecting component of the pickup mechanism according to embodiment I of the present invention. The working process of the pickup mechanism provided by the present disclosure is introduced below in combination with FIG. 4.

In an initial state, the high-friction part 122 of the pickup roller 1 is positioned at the set stop position, and a first entity part 523 adjacent to the end position b of the position detecting aperture 521 is positioned in the optical path between the light emitter 511 and the light receiver 512, thus the sensor 51 outputs the first detection signal. When the pickup roller 1 starts to rotate along the set direction (the anticlockwise direction as shown in FIG. 3), the detecting disc 52 rotates synchronously along with the pickup roller 1, and the first entity parts 523 and the speed measuring apertures 522 of the detecting disc 52 pass through the optical path of the sensor 51 alternatively, thus the sensor 51 outputs the first detection signal and the second detection signal alternatively. Since the detection span under the situation that the first entity part 523 is matched with the sensor 51 and the detection span under the situation that the speed measuring aperture 522 is matched with the sensor 51 are equal, the time for outputting the first detection signal by the sensor 51 and the time for outputting the second detection signal by the sensor 51 are equal, both of which are t2. A controller can obtain the rotation speed of the detecting disc 52 (i.e., the rotation speed of the pickup roller 1) by performing calculations according to the time t2 and the detection span L2 under the situation that the first entity part 523 or the speed measuring aperture 522 is matched with the sensor 51. When the rotation speed of the pickup roller 1 is unequal to the set rotation speed, the driving torque output by the driving component of the paper currency processing machine is adjusted, so as to make the rotation speed of the pickup roller be equal to the set rotation speed.

With the continuous rotation of the pickup roller 1, the position detecting aperture 521 passes through the optical path between the light emitter 511 and the light receiver 512 of the sensor 51. Since the detection span L1 under the situation that the position detecting aperture 521 is matched with the sensor 51 is much greater than the detection span L2 under the situation that the speed measuring aperture 522 is matched with the sensor 51, the time t1 for outputting the second detection signal when the sensor 51 is matched with the position detection aperture 521 is much greater than the time t2 for outputting the second detection signal when the sensor 51 is matched with the speed measuring aperture 522. If it is needed to stop the rotation of the pickup roller 1, the controller detects the signals output by the sensor 51. Specifically, the pickup roller 1 is controlled to stop rotating if the sensor 51 outputs the first detection signal after outputting the second detection signal for a duration of t2. At this moment, the first entity part 523 adjacent to the end position b of the position detecting aperture 521 is positioned in the optical path between the light emitter 511 and the light receiver 512, and the high-friction part 122 of the pickup roller 1 stops at the set stop position exactly.

The pickup mechanism provided by the present disclosure includes the pickup roller and the detecting component, and the detecting component includes the detecting disc rotating synchronously with the pickup roller, and the sensor matched with the detecting disc. The detecting disc is provided with the position detecting aperture and the plurality of speed measuring apertures which are uniformly distributed along the circumference with the shaft of the pickup roller as the center of the circle, and entity parts among the plurality of speed measuring apertures and between the speed measuring apertures and the position detecting aperture. Along the rotation direction of the detecting disc, the end position of the position detecting aperture, matched with the sensor, is associated with the position of the high-friction part of the pickup roller, so as to control the rotation stop position of the pickup roller. Moreover, when the pickup roller rotates at a constant speed, the time needed by the sensor for passing through the position detecting aperture is greater than the time needed for passing through the speed measuring apertures. When the pickup roller rotates, the detecting disc is matched with the sensor, and the signal output by the sensor changes according to set rules. The rotation speed of the pickup roller can be calculated according to the change condition of the signal output by the sensor, then the driving torque output by the driving component of the paper currency processing machine can be adjusted according to the calculated rotating torque, so that the rotation speed of the pickup roller is equal to the set rotation speed. Moreover, the pickup roller also can be controlled to stop at the set stop position according to the change condition of the signal output by the sensor. Therefore, compared with the pickup mechanism in the existing art, the pickup mechanism provided by the present disclosure not only can detect the rotation speed of the pickup roller, but also can detect the position of the pickup roller, so that the problem of unreliable conveyance is avoided by adjusting the rotation speed of the pickup roller and controlling the stop position of the pickup roll, and the reliability of the pickup mechanism is improved.

FIG. 5 is a structural side view of a pickup mechanism according to embodiment II of the present invention, with the pickup roller stop at a set stop position. As shown in FIG. 5, in the present embodiment, the entity part further includes two second entity parts 523′ which are positioned at two sides of the position detecting aperture 521 and between the position detecting aperture 521 and the speed measuring apertures 522. A detection span L4 under a situation that the second entity part 523′ is matched with the sensor 51 is unequal to the detection span L3 under the situation that the first entity part 523 between the plurality of speed measuring apertures 522 is matched with the sensor 51. In the present embodiment, the detection span L4 under the situation that the second entity part 523′ is matched with the sensor 51 is greater than the detection span L3 under the situation that the first entity part 523 is matched with the sensor 51. When the pickup roller 1 rotates, time t3 for outputting the first detection signal when the second entity part 523′ is matched with the sensor 51 is greater than the time t2 for outputting the first detection signal when the first entity part 523 is matched with the sensor 51.

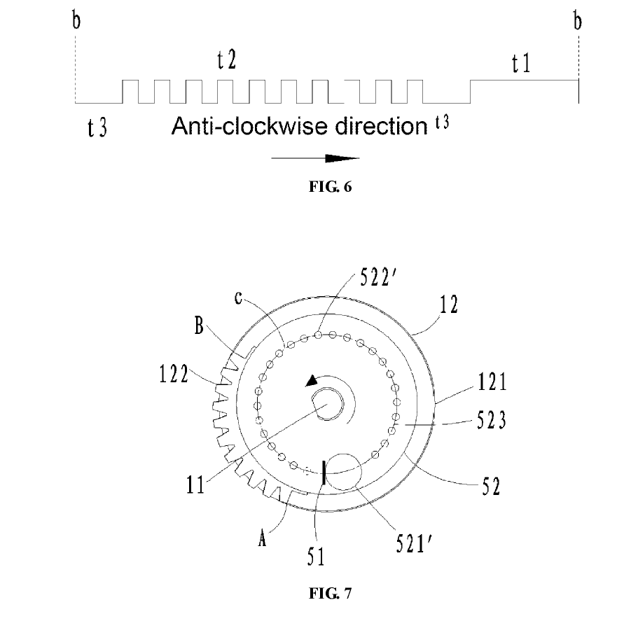

FIG. 6 is a schematic of an output signal of the detecting component of the pickup mechanism according to embodiment II of the present invention. As shown in FIG. 6, In the initial state, the high-friction part 122 of the pickup roller 1 is stopped at the set position, and the second entity part 523′ adjacent to the end position b of the position detecting aperture 521 is positioned in the optical path between the light emitter 511 and the light receiver 512, thus the sensor 51 outputs the first detection signal. When the pickup roller 1 starts to rotate, the detecting disc 52 rotates synchronously along with the pickup roller 1, and the second entity part 523′ of the detecting disc 52 passes through the optical path between the light emitter 511 and the light receiver 512, thus the sensor 51 outputs the first detection signal for a duration of t3. When the speed measuring apertures 522 and the first entity parts 523 pass through the optical path between the light emitter 511 and the light receiver 512 of the sensor 51 alternatively, the sensor 51 outputs the first detection signal and the second detection signal for a duration of t2 alternatively. The controller can calculate the rotation speed of the detecting disc 52 (i.e., the rotation speed of the pickup roller 1), according to the time t2 and the detection spans L2 and L3 under the situation that the first entity part 523 or the speed measuring aperture 522 is matched with the sensor 51. With the continuous rotation of the pickup roller 1, the second entity part 523′ adjacent to an initial edge “a” of the position detecting aperture 521 passes through the optical path between the light emitter 511 and the light receiver 512 of the sensor 51, thus the sensor 51 outputs the second detection signal for a duration of t2 after outputting the first detection signal for a duration of t3. When it is needed to stop the rotation of the pickup roller 1, the controller detects the signal output by the sensor 51. Specifically, when the sensor 51 outputs the first detection signal for a duration of t3, the pickup roller 1 is controlled to reduce the rotation speed, and when the sensor 51 changes from outputting the second detection signal for a duration of t2 to outputting the first detection signal, the pickup roller 1 is controlled to stop rotating. At this moment, since the rotation speed of the pickup roller 1 is reduced, the problem of overshooting caused by direct stop of the pickup roller 1 from high-speed movement is avoided and the accuracy of the stop position of the pickup roller 1 is guaranteed.

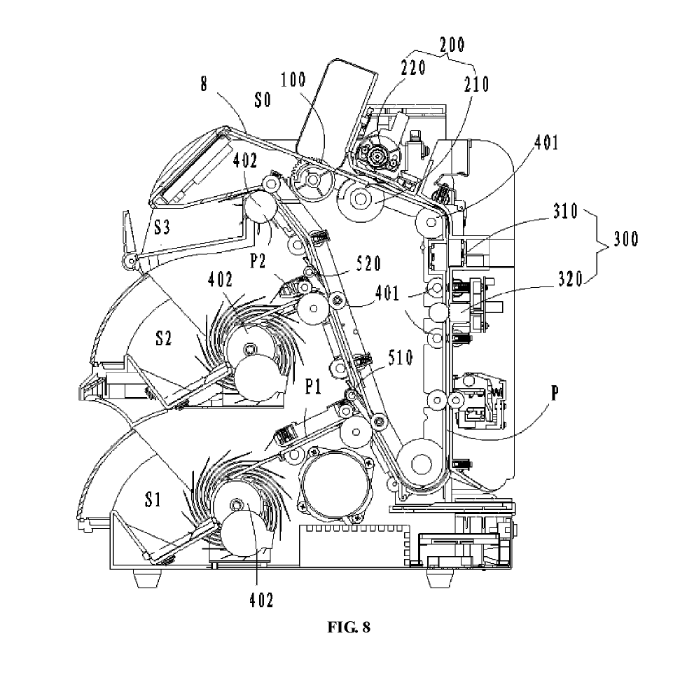

FIG. 7 is a structural side view of a pickup mechanism according to embodiment III of the present invention. As shown in FIG. 7, in the present embodiment, the position detecting aperture 521′ and each speed measuring aperture 522′ are all circular, and the position detecting aperture 521′ is a large round hole, while the speed measuring apertures 522′ are small round holes. Along the rotation direction of the pickup roller 1, a detection span under a situation that the position detecting aperture 521′ is matched with the sensor 51 is greater than a detection span under a situation that the speed measuring aperture 522′ is matched with the sensor 51.

FIG. 8 is a structural sectional view of an embodiment of a paper currency processing machine using the pickup mechanism provided by the present disclosure. In the present embodiment, the paper currency processing machine is a paper currency sorter. As shown in FIG. 8, the paper currency sorter is provided with a paper currency inlet S0, at least one paper currency outlet and a paper currency returning port S3 which are communicated with outside. The paper currency sorter includes a main passage P, at least one auxiliary passage, a pickup mechanism 100, a separating mechanism 200, a paper currency authentication mechanism 300, a conveying mechanism, a reversing mechanism and a driving mechanism (not shown in the figures),

The paper currency inlet S0 is located at a starting position of the main passage P. A tray 8 is arranged at the paper currency inlet S0 and is configured to stack the paper currencies to be processed. Both of the pickup mechanism 100 and the separating mechanism 200 are arranged at the paper currency inlet S0. The pickup mechanism 100 is configured to convey the paper currencies stacked at the paper currency inlet S0 to the separating mechanism 200 one by one, and can adopt any of the above pickup mechanism. Please see the description of the above embodiments for structural form and working principle of the pickup mechanism, which are omitted herein. The sleeve 12 of the pickup roller 1 of the pickup mechanism 100 protrudes out of an upper surface of the tray 8 through openings (not shown in the figure) on the tray 8, and can be contacted with the paper currencies stacked on the tray 8. The length of the high-friction part 122 of the pickup roller 1 along the rotation direction of the pickup roller 1 is greater than or equal to the distance between the pickup roller 1 and the separating mechanism 200. A pulley 111 fixedly arranged at the shaft end of the shaft 11 of the pickup roller 1 is in transmission connection with the driving mechanism, thus the pickup roller 1 can rotate along the paper currency feeding direction while driven by the driving mechanism. When the pickup roller 1 stops at the set stop position, there is a set distance between the starting position “a” of the high-friction part 122 of the pickup roller 1 and the tray 8 along the paper currency feeding direction. At this moment, the first entity part 523 adjacent to the end position “b” of the position detecting aperture 521 is positioned in the optical path between the light emitter 511 and the light receiver 512 of the sensor 51, and the sensor 51 outputs the first detection signal.

The separating mechanism 200 is configured to separate the paper currencies conveyed from the pickup mechanism 100 so as to convey a single piece of paper currency to the main passage P. The separating mechanism 200 includes a separating roller 210 and a reversal roller 220 which are oppositely arranged at an interval, and the distance between the separating roller 210 and the reversal roller 220 is greater than the thickness of a single piece of paper currency and is less than the thickness of two pieces of paper currency. The separating roller 210 is in transmission connection with the driving mechanism, and can rotate in the paper currency feeding direction while driven by the driving mechanism. The reversal roller 220 is in transmission connection with the driving mechanism, and can rotate in the paper currency returning direction while driven by the driving mechanism.

The paper currency authentication mechanism 300 is arranged in the main passage P, and is configured to identify the authenticity and the denomination of the paper currency. The paper currency authentication mechanism 300 includes an image detecting mechanism 310 and a magnetic detecting mechanism 320. The image detecting mechanism 310 includes two opposite image sensors for acquiring image information on front surface and back surface of the paper currency. The magnetic detecting mechanism 320 is configured to detect magnetic information of a security thread in the paper currency. A controller of the paper currency sorter determines the authenticity and the denomination of the paper currency and the like according to detection results of the image detecting mechanism 310 and the magnetic detecting mechanism 320.

The paper currency outlets are communicated with the main passage P through the auxiliary passages, and are configured to contain a paper currency that is authenticated as normal paper currency by the paper currency authentication mechanism 300. A paper currency returning port S3 is located at the end of the main passage P, and is configured to contain a paper currency that is authenticated as abnormal paper currency by the paper currency authentication mechanism 300, such as counterfeit paper currency, incomplete paper currency. The conveying mechanism is configured to drive the paper currency to move along the main passage P or the auxiliary passages, and includes a plurality of conveying roller set and a plurality of impellers 402. The plurality of conveying roller set are arranged on the main passage P or the auxiliary passages, and are configured to drive the paper currency to move in the main passage P or the auxiliary passages. The number of the impellers 402 of the conveying mechanism is equal to the total number of the paper currency outlets and the paper currency returning port S3, and an impeller 402 is arranged between each paper currency outlet and each auxiliary passage, which is configured to convey the paper currency in the auxiliary passages to the paper currency outlet. Moreover, an impeller 402 is arranged between the paper currency returning port S3 and the main passage P, which is configured to convey the paper currency in the main passage P to the paper currency returning port S3.

In the present embodiment, the paper currency sorter includes the paper currency inlet S0, two paper currency outlets (i.e., a first paper currency outlet S1 and a second paper currency outlet S2), two auxiliary passages (i.e., a first auxiliary passage P1 and a second auxiliary passage P2) and the paper currency returning port S3. The conveying mechanism includes three impellers 402. The first paper currency outlet S1 is communicated with the main passage P through the first auxiliary passage P1, and is configured to contain a first type of paper currency authenticated as normal paper currency by the paper currency authentication mechanism 300, such as RMB in 100-yuan denomination. The second paper currency outlet S2 is communicated with the main passage P through the second auxiliary passage P2, and is configured to contain a second type of paper currency authenticated as normal paper currency by the paper currency authentication mechanism 300, such as RMB in 50-yuan denomination. The three impellers 402 of the conveying mechanism are arranged between the first auxiliary passage P1 and the first paper currency outlet 51, between the second auxiliary passage P2 and the second paper currency outlet S2 and between the main passage P and the paper currency returning port S3 respectively.

The reversing mechanism includes a first reverser 510, a second reverser 520, a first driving part and a second driving part (not shown in the figure). The first reverser 510 is arranged at an intersection of the main passage P and the first auxiliary passage P1, and is movably connected with the frame (not shown in the figure) of the paper currency sorter. The second reverser 520 is arranged at an intersection of the main passage P and the second auxiliary passage P2, and is movably connected with the frame. The first driving part and the second driving part may be cams or electromagnets and the like. The first driving part is connected with the first reverser 510, and under the driving of the first driving part, the first reverser 510 has a first position and a second position. When the first reverser 510 is positioned at the first position, the main passage P is communicated with the first auxiliary passage P1, thus the paper currency in the main passage P is conveyed to the first auxiliary passage P guided by the first reverser 510. When the first driving part drives the first reverser 510 to move to the second position, the path between the main passage P and the first auxiliary passage P1 is disconnected. Therefore, the paper currency can only move downstream continuously along the main passage P. The second driving part is connected with the second reverser 520, under the driving of the second driving part, the second reverser 520 has a first position and a second position. When the second reverser 520 is positioned at the first position, the main passage P is communicated with the second auxiliary passage P2, thus the paper currency in the main passage P is conveyed to the second auxiliary passage P2 guided by the second reverser 520. When the second driving part drives the second reverser 520 to move to the second position, the path between the main passage P and the second auxiliary passage P2 is disconnected, the main passage P is communicated with the paper currency returning port S3, thus the paper currency in the main passage P is conveyed to the paper currency returning port S3.

A working process of the pickup mechanism of the paper currency processing machine provided by the present disclosure is introduced below.

In a standby state, the high-friction part 122 of the pickup roller 1 of the pickup mechanism 100 is positioned at the set stop position, the first entity part 523 adjacent to the end position “b” of the position detecting aperture 521 is positioned in the optical path between the light emitter 511 and the light receiver 512 of the sensor 51, thus the sensor 51 outputs the first detection signal. When a stack of paper currencies are stacked on the tray 8, the sleeve 12 of the pickup roller 1 is contacted with a paper currency at the bottom of the stack of paper currencies, and the controller of the paper currency processing machine controls the driving mechanism to drive the pickup roller 1 and the separating roller 210 to rotate in the paper currency feeding direction and drive the reversal roller 220 to rotate in the paper currency returning direction. In the rotation process of the pickup roller 1, the detecting disc 52 rotates synchronously along with the pickup roller, and the controller calculates the rotation speed of the pickup roller 1 according to the detection signals output by the sensor 51. The controller controls the driving mechanism to adjust the driving torque when the rotation speed of the pickup roller 1 is unequal to the set speed, so that the rotation speed of the pickup roller 1 is equal to the set rotation speed, thereby ensuring that the paper currencies are conveyed to the separating mechanism 200 in sequence one by one. When all the paper currencies on the tray 8 are sent out, the controller detects the output signal of the sensor 51. If the sensor 51 outputs the first detection signal after outputting the second detection signal for a duration of t2, the pickup roller 1 is controlled to stop rotating. At this moment, the first entity part 523 adjacent to the end position “b” of the position detecting aperture 521 is positioned in the optical path between the light emitter 511 and the light receiver 512, and the high-friction part 122 of the pickup roller 1 stops at the set stop position exactly.

The paper currency processing machine adopts the pickup mechanism provided by the present disclosure. Therefore, the paper currency processing machine is capable of detecting the speed of the pickup roller at any time and adjusting the rotation speed of the pickup roller at any time according to a detection result, thereby ensuring that the paper currencies are sent out one by one. After the conveyance of the paper currencies is completed, the pickup roller can further be stopped at the set stop position according to the detection signal output by the sensor, thereby ensuring that the pickup roller is started at the same position for every time and improving the reliability of the product.

The above descriptions are only embodiments of the present disclosure, rather than a limit to the present disclosure. Those skilled in the art should understand that the present disclosure may have a variety of modifications and changes. Any modification, equivalent replacement, improvement and the like made within the spirit and the principle of the present disclosure shall be included in the protection scope of the present disclosure.

1. A pickup mechanism, comprising
a pickup roller having a shaft and a sleeve, a part of a periphery of the sleeve comprising a high-friction part,
wherein the pickup mechanism further comprises a detecting component, and the detecting component comprises a detecting disc coaxially and fixedly connected with the shaft, and a sensor matched with the detecting disc,
wherein a position detecting aperture is arranged on the detecting disc; along a rotation direction of the detecting disc, an end position of the position detecting aperture, matched with the sensor, is associated with a position where the high-friction part of the pickup roller is located, so as to control a rotation stop position of the pickup roller.

2. The pickup mechanism according to claim 1, further comprising
a plurality of speed measuring apertures which are arranged on a same circumference together with the position detecting aperture,
wherein a detection span L1 under a situation that the position detecting aperture is matched with the sensor is unequal to a detection span L2 under a situation that the speed measuring aperture is matched with the sensor.

3. The pickup mechanism according to claim 1, wherein
along the rotation direction of the detecting disc, the end position b of the position detecting aperture, matched with the sensor, is aligned to or staggered with a starting position A of the high-friction part.

4. The pickup mechanism according to claim 2, wherein
the position detecting aperture and the speed measuring apertures are all round holes, wherein a diameter of the position detecting aperture is larger than that of each speed measuring aperture.

5. The pickup mechanism according to claim 2, wherein
the position detecting aperture and the speed measuring apertures are all sector-shaped ring sections, and a central angle of the position detecting aperture is larger than that of each speed measuring aperture.

6. The pickup mechanism according to claim 2, wherein
along a circumferential direction of the detecting disc, a detection span L4 under a situation that entity parts at two sides of the position detecting aperture are matched with the sensor is larger than a detection span L3 under a situation that an entity part between two adjacent speed measuring apertures is matched with the sensor.

7. The pickup mechanism according to claim 1, wherein
the sensor is a photoelectric sensor, and comprises a light emitter and a light receiver which are arranged oppositely, and the detecting disc is positioned between the light emitter and the light receiver.

8. A paper currency processing machine, comprising
a paper currency tray,
a pickup mechanism, and
a paper currency separating mechanism positioned downstream of the pickup mechanism, wherein
the pickup mechanism comprising:
a pickup roller having a shaft and a sleeve, a part of a periphery of the sleeve comprising a high-friction part,
wherein the pickup mechanism further comprises a detecting component, and the detecting component comprises a detecting disc coaxially and fixedly connected with the shaft, and a sensor matched with the detecting disc,
wherein a position detecting aperture is arranged on the detecting disc; along a rotation direction of the detecting disc, an end position of the position detecting aperture, matched with the sensor, is associated with a position where the high-friction part of the pickup roller is located, so as to control a rotation stop position of the pickup roller.

9. The paper currency processing machine according to claim 8, wherein
the paper currency processing machine is a paper currency sorter, and comprises a paper currency inlet S0 and at least two paper currency outlets, and the paper currency tray and the pickup mechanism are arranged at the paper currency inlet S0.

10. A sheet medium processing device, comprising a pickup mechanism, wherein the pickup mechanism comprising:
a pickup roller having a shaft and a sleeve, a part of a periphery of the sleeve comprising a high-friction part,
wherein the pickup mechanism further comprises a detecting component, and the detecting component comprises a detecting disc coaxially and fixedly connected with the shaft, and a sensor matched with the detecting disc,
wherein a position detecting aperture is arranged on the detecting disc; along a rotation direction of the detecting disc, an end position of the position detecting aperture, matched with the sensor, is associated with a position where the high-friction part of the pickup roller is located, so as to control a rotation stop position of the pickup roller.

11. The paper currency processing machine according to claim 8, wherein the pickup mechanism further comprises:
a plurality of speed measuring apertures which are arranged on a same circumference together with the position detecting aperture,
wherein a detection span L1 under a situation that the position detecting aperture is matched with the sensor is unequal to a detection span L2 under a situation that the speed measuring aperture is matched with the sensor.

12. The paper currency processing machine according to claim 8, wherein
along the rotation direction of the detecting disc, the end position b of the position detecting aperture, matched with the sensor, is aligned to or staggered with a starting position A of the high-friction part.

13. The paper currency processing machine according to claim 11, wherein
the position detecting aperture and the speed measuring apertures are all round holes, wherein a diameter of the position detecting aperture is larger than that of each speed measuring aperture.

14. The paper currency processing machine according to claim 11, wherein
the position detecting aperture and the speed measuring apertures are all sector-shaped ring sections, and a central angle of the position detecting aperture is larger than that of each speed measuring aperture.

15. The paper currency processing machine according to claim 11, wherein
along a circumferential direction of the detecting disc, a detection span L4 under a situation that entity parts at two sides of the position detecting aperture are matched with the sensor is larger than a detection span L3 under a situation that an entity part between two adjacent speed measuring apertures is matched with the sensor.

16. The paper currency processing machine according to claim 8, wherein
the sensor is a photoelectric sensor, and comprises a light transmitter and a light receiver which are arranged oppositely, and the detecting disc is positioned between the light transmitter and the light receiver.
